(19) United States
(12) Patent Application Publication
(10) Pub. No.: US 2023/0279827 A1
(43) Pub. Date: Sep. 7, 2023

(54) THRUST CHAMBER DEVICE AND METHOD FOR OPERATING A THRUST CHAMBER DEVICE

(71) Applicant: Deutsches Zentrum fuer Luft- und Raumfahrt e.V., Bonn (DE)

(72) Inventor: Markus Ortelt, Flein (DE)

(21) Appl. No.: 18/178,697

(22) Filed: Mar. 6, 2023

Related U.S. Application Data
(63) Continuation of application No. PCT/EP2021/074678, filed on Sep. 8, 2021.

(30) Foreign Application Priority Data
Sep. 8, 2020 (DE) 10 2020 123 422.8

(51) Int. Cl. F02K 9/64

(52) U.S. Cl. CPC F02K 9/64

(57) ABSTRACT

The invention relates to a thrust chamber device, comprising a thrust chamber with a thrust space that has a first portion, a second portion adjoining the first portion, and a third portion adjoining the second portion, wherein the thrust space is delimited in all three portions by an outer nozzle wall with an outer thrust space surface, which outer thrust space surface tapers in the first and second portion toward the third portion and in the third portion expands away from the second portion, wherein a narrowest point is formed at the transition from the second portion to the third portion, wherein the first portion is delimited by an inner nozzle wall with an inner thrust space surface, and wherein the thrust chamber device comprises a regenerative cooling unit for cooling the inner nozzle wall and the outer nozzle wall with a coolant.

### CROSS-REFERENCE TO RELATED APPLICATIONS

This application is a continuation of international application number PCT/EP2021/074678 filed on Sep. 8, 2021 and claims the benefit of German application number 10 2020 123 422.8 filed on Sep. 8, 2020, which are incorporated herein by reference in their entirety and for all purposes.

### FIELD OF THE INVENTION

The present invention relates to thrust chamber devices generally, and more specifically to a thrust chamber device, comprising a thrust chamber with a thrust space, which has a first portion, a second portion adjoining the first portion, and a third portion adjoining the second portion, wherein the thrust space is delimited in all three portions by an outer nozzle wall with an outer thrust space surface, which outer thrust space surface tapers in the first and second portion toward the third portion and in the third portion expands away from the second portion, wherein a narrowest point is formed at the transition from the second portion to the third portion, wherein the first portion is delimited by an inner nozzle wall with an inner thrust space surface, which tapers toward the second portion and wherein formed between the inner thrust space surface and the outer thrust space surface is an annular combustion space, which extends over the first portion.

The present invention also relates to operating methods generally, and more specifically to a method for operating a thrust chamber device.

Furthermore, the invention relates to engines generally, and more specifically to an engine, in particular for a flying object or an aircraft.

In addition, the present invention relates to flying objects or aircrafts generally, and more specifically to a flying object or an aircraft, comprising a first propellant store for at least one first propellant component, a second propellant store for at least one second propellant component, and an engine.

### BACKGROUND OF THE INVENTION

Thrust chamber devices of the kind described at the outset are used, for example, in engines for generating thrust, for example for driving a flying object like a rocket, in particular by combusting propellant components. One propellant component may be, in particular, a fuel. For example, liquid hydrogen (LH₂) may be used as a fuel and liquid oxygen (LOX) may be used as a further propellant component, which takes on the function of an oxidizing agent, the so-called oxidizer.

An example for a thrust chamber device of the kind described at the outset is known, in particular, from WO 2018/167204 A1. In the case of the known thrust chamber device, a plurality of first propellant inlets are formed in the region of the outer nozzle wall for introducing a first propellant component therethrough into the thrust chamber. Here, the outer nozzle wall is simultaneously cooled, namely by the first propellant component, which is thereby heated up. However, with such a transpiration cooling, it is necessary to inject more propellant into the thrust space than is required for the cooling of the outer nozzle wall. As a result, the first propellant component is then not completely converted in the thrust space or combustion chamber.

### SUMMARY OF THE INVENTION

In a first aspect of the invention, a thrust chamber device is provided. The thrust chamber device comprises a thrust chamber with a thrust space that has a first portion, a second portion adjoining the first portion, and a third portion adjoining the second portion. The thrust space is delimited in all three portions by an outer nozzle wall with an outer thrust space surface, which outer thrust space surface tapers in the first and second portion toward the third portion and in the third portion expands away from the second portion. A narrowest point is formed at the transition from the second portion to the third portion. The first portion is delimited by an inner nozzle wall with an inner thrust space surface, which tapers toward the second portion. Formed between the inner thrust space surface and the outer thrust space surface is an annular combustion space, which extends over the first portion. The thrust chamber device comprises a regenerative cooling unit for cooling the inner nozzle wall and the outer nozzle wall with a coolant.

In a second aspect of the invention, an engine is provided, in particular for a flying object or an aircraft, the engine comprises a thrust chamber device, said thrust chamber device comprises a thrust chamber with a thrust space that has a first portion, a second portion adjoining the first portion, and a third portion adjoining the second portion. The thrust space is delimited in all three portions by an outer nozzle wall with an outer thrust space surface, which outer thrust space surface tapers in the first and second portion toward the third portion and in the third portion expands away from the second portion. A narrowest point is formed at the transition from the second portion to the third portion. The first portion is delimited by an inner nozzle wall with an inner thrust space surface, which tapers toward the second portion. Formed between the inner thrust space surface and the outer thrust space surface is an annular combustion space, which extends over the first portion. The thrust chamber device comprises a regenerative cooling unit for cooling the inner nozzle wall and the outer nozzle wall with a coolant.

In a third aspect of the invention, a flying object or aircraft is provided. The flying object or aircraft comprises a first propellant store for at least one first propellant component, a second propellant store for at least one second propellant component, and an engine. The engine comprises a thrust chamber device. The thrust chamber device comprises a thrust chamber with a thrust space that has a first portion, a second portion adjoining the first portion, and a third portion adjoining the second portion. The thrust space is delimited in all three portions by an outer nozzle wall with an outer thrust space surface, which outer thrust space surface tapers in the first and second portion toward the third portion and in the third portion expands away from the second portion. A narrowest point is formed at the transition from the second portion to the third portion. The first portion is delimited by an inner nozzle wall with an inner thrust space surface, which tapers toward the second portion. Formed between the inner thrust space surface and the outer thrust space surface is an annular combustion space, which extends over the first portion. The thrust chamber device comprises a regenerative cooling unit for cooling the inner nozzle wall and the outer nozzle wall with a coolant.

In a fourth aspect of the invention, a method for operating a thrust chamber device is provided. Thrust chamber device comprises a thrust chamber with a thrust space that has a first portion, a second portion adjoining the first portion, and a third portion adjoining the second portion. The thrust space is delimited in all three portions by an outer nozzle wall with an outer thrust space surface, which outer thrust space surface tapers in the first and second portion toward the third portion and in the third portion expands away from the second portion. A narrowest point is formed at the transition from the second portion to the third portion. The first portion is delimited by an inner nozzle wall with an inner thrust space surface, which tapers toward the second portion. Formed between the inner thrust space surface and the outer thrust space surface is an annular combustion space, which extends over the first portion. The thrust chamber device comprises a regenerative cooling unit for cooling the inner nozzle wall and the outer nozzle wall with a coolant. The inner nozzle wall and the outer nozzle wall are regeneratively cooled with a coolant.

### BRIEF DESCRIPTION OF THE DRAWING FIGURES

The foregoing summary and the following description may be better understood in conjunction with the drawing figures, of which:

FIG. 1: shows a schematic depiction of a thrust space contour with two hyperboloids for defining the inner and outer nozzle walls;

FIG. 2: shows a schematic depiction of an embodiment of a thrust chamber device with serial regenerative cooling of the outer nozzle wall and the inner nozzle wall;

FIG. 3: shows a schematic depiction of a further embodiment of a thrust chamber device with parallel regenerative cooling of the inner nozzle wall and the outer nozzle wall;

FIG. 4: shows a schematic depiction of a further embodiment of a thrust chamber device with parallel cooling of the inner nozzle wall and the outer nozzle wall;

FIG. 5: shows a schematic depiction of a further embodiment of a thrust chamber device with serial cooling of the inner nozzle wall and the outer nozzle wall;

FIG. 6: shows a schematic depiction of an embodiment of an injection head of a thrust chamber device;

FIG. 7: shows a schematic depiction of a coolant flow switching unit;

FIG. 8: shows a schematic depiction of an engine; and

FIG. 9: shows a schematic depiction of a flying object or an aircraft.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a thrust chamber device, comprising a thrust chamber with a thrust space that has a first portion, a second portion adjoining the first portion, and a third portion adjoining the second portion, wherein the thrust space is delimited in all three portions by an outer nozzle wall with an outer thrust space surface, which outer thrust space surface tapers in the first and second portion toward the third portion and in the third portion expands away from the second portion, wherein a narrowest point is formed at the transition from the second portion to the third portion, wherein the first portion is delimited by an inner nozzle wall with an inner thrust space surface, which tapers toward the second portion, and wherein formed between the inner thrust space surface and the outer thrust space surface is an annular combustion space, which extends over the first portion, wherein the thrust chamber device comprises a regenerative cooling unit for cooling the inner nozzle wall and the outer nozzle wall with a coolant.

Regeneratively cooling the inner nozzle wall and the outer nozzle wall with the coolant has the advantage, in particular, that the heat or enthalpy absorbed when cooling the two nozzle walls can be fully used for driving, for example, a turbine, with which conveying units, in particular turbo pumps, for propellant components to be combusted in the thrust space can be driven. Furthermore, as a result of the proposed regenerative cooling, it is not necessary to inject more of the first propellant component into the thrust space than is required for an optimal combustion. In addition, there are further advantages for a regenerative cooling unit in conjunction with the specially shaped thrust space of the thrust chamber. In particular, a length of the thrust chamber can be significantly reduced in comparison to a classic contour of a thrust space design with a cylindrical combustion chamber wall. An optimization in this respect can be achieved, in particular, through the shape of the inner and outer nozzle wall, for example by both nozzle walls being shaped as hyperboloids of revolution. Length reductions and thus significant weight savings of the thrust chamber device of up to 50% offer great advantages, in particular in the space sector. In particular, more payload can be transported with the same power of the thrust chamber. Due to the shorter design, i.e. a reduced overall length compared to conventional combustion chamber designs, an excessive pressure loss due to enthalpy absorption by the coolant when flowing through the nozzle wall can also be avoided. Furthermore, it is also possible, for example, to divide the coolant to the inner nozzle wall and the outer nozzle wall for cooling, i.e. to cool both nozzle walls in parallel, or to perform such a cooling of the nozzle wall in series. Thus, in particular, different cooling modes can be used, which are optimally adapted to different operating modes of the thrust chamber device. In particular, a serial cooling of the inner and outer nozzle wall is not possible at all with transpiration cooling.

It is advantageous if a regenerative cooling unit comprises a plurality of inner coolant channels in the inner nozzle wall and a plurality of outer coolant channels in the outer nozzle wall and if the plurality of inner coolant channels and the plurality of outer channels are configured to be flowed through by the coolant. The nozzle walls can be efficiently cooled in this way. The coolant channels may extend substantially in parallel to a longitudinal axis or axis of symmetry of the thrust chamber or may also be configured in the shape of a spiral in the nozzle walls relative to the longitudinal axis or axis of symmetry. An absorption of heat in the coolant and, in particular, a pressure loss due to the absorption of heat during cooling can thus be optimized depending on a size of the thrust chamber device.

Cooling channels can then be formed in the nozzle walls of the thrust chamber device, in particular, in a simple manner if the inner nozzle wall and/or the outer nozzle wall are made of a ceramic and/or metallic material.

The inner thrust space surface and/or the outer thrust space surface at least partially have the shape of a hyperboloid of revolution or a continuously concave longitudinal sectional line. In particular, the inner thrust space surface and/or the outer thrust space surface may have a shape which is similar to that of a hyperboloid of revolution, insofar as they have a continuously concave longitudinal sectional line. For example, regeneratively cooled two-sheet hyperboloid thrust spaces or combustion chambers can thus be formed. In particular, it is thus possible in a simple manner to predetermine a constant cross section of the thrust space, i.e., for example, the thrust space may be configured as an annular space between the outer thrust space surface and the inner thrust space surface in the first portion. Furthermore, it is possible to delimit the different portions of the thrust space from thrust space surfaces that define differently curved hyperboloids of revolution.

In order to achieve efficient cooling and guidance of the combustion products in the thrust space, it is advantageous if the inner thrust space surface is of convexly curved or substantially convexly curved configuration pointing in the direction toward the outer thrust space surface. Substantially convexly curved means, in particular, that an envelope of the inner thrust space surface is convexly curved. The inner thrust space surface may then also have short regions with concave curvature, for example in order to vary, in particular to enlarge, a cross-sectional area of the annular combustion space in order to form propellant mixing regions.

It is advantageous if the outer thrust space surface is of convexly curved or substantially convexly curved configuration pointing in the direction toward the inner thrust space surface. Compared to a classic contour of an outer nozzle wall of a thrust chamber with a substantially cylindrical combustion space, typical boundary layer turbulences can thus be avoided, which are also referred to as Görtler vortices. Such vortices form, in particular, in the region of the narrowest point of the thrust chamber, which is defined by the outer nozzle wall.

In accordance with a further preferred embodiment, provision may be made that the thrust chamber defines a longitudinal axis and that the thrust chamber, in particular the first portion and/or the second portion and/or the third portion, are of rotationally symmetrical configuration relative to the longitudinal axis. This simplifies, in particular, the structure and the construction of the thrust chamber device.

It is advantageous if the outer thrust space surface and/or the inner thrust space surface are of rotationally symmetrical configuration relative to the longitudinal axis. For example, a construction of the thrust chamber device can thus be simplified.

The annular combustion space preferably has a constant or substantially constant cross sectional area. Although diameters of the inner and outer thrust space surfaces can change along the extent of the thrust space in parallel to the longitudinal axis, a quasi-cylindrical annular combustion space can be formed in this way, which transitions into a convergent thrust chamber portion for the purpose of sound passage without changing the direction of curvature of the thrust space surfaces, namely due to the geometric interaction of purely convex outer and purely convex inner thrust space surfaces. In particular, due to the tapering outer nozzle wall, an increased heating thereof can be prevented, in particular, by a coolant flow being increased, for example by enlarging the coolant channels in the region of a smallest diameter of the outer thrust space surface. The constant cross sectional area makes it possible, in particular, to form a quasi-cylindrical combustion chamber zone without a cross sectional constriction, i.e., a combustion chamber zone analogous to the standard design, namely the cylindrical portion of a rocket combustion chamber.

In order to enable a targeted, in particular stoichiometric, chemical reaction of the propellant components, it is favorable if the thrust chamber device comprises a plurality of first propellant inlets for a first propellant component and a plurality of second propellant inlets for a second propellant component. A plurality of propellant inlets for the different propellant components enables, in particular, an optimal mixing thereof already upon the entrance or near the entrance thereof into the thrust space.

It is advantageous if the first portion of the thrust space is delimited on an end pointing away from the second portion by an injection wall, which connects the inner nozzle wall and the outer nozzle wall to one another, and if the plurality of first propellant inlets and the plurality of second propellant inlets are arranged or formed in the injection wall. In particular, all propellant inlets in the thrust chamber device may be arranged or formed in the injection wall. This makes it possible, in particular, to introduce the propellants into the thrust space in a direction predetermined by the annular combustion space in the direction toward the third portion.

The injection wall is preferably of annular or rotationally symmetrical or hyperboloid-like configuration for closing the ring-shaped annular combustion space. This makes it possible, in particular, to easily close the thrust space on the proximal side, i.e. at its end pointing away from the third portion.

In order to be able to inject the propellant components into the thrust space in a defined manner, it is advantageous if the thrust chamber device comprises an injection head and if the injection head comprises the injection wall. The injection head with the injection wall can thus, in particular, close the annular combustion space. The injection head may be configured, in particular, having one, two, or more distribution spaces, in order to be able to introduce the different propellant components into the thrust space in a targeted manner and simultaneously through the plurality of propellant inlets.

It is advantageous if the plurality of first propellant inlets and the plurality of second propellant inlets are configured in the form of channels, which have channel openings pointing into the annular combustion space. The propellant components can thus be introduced into the annular combustion space in a defined and simple manner, namely, in particular, already having a flow component in a direction parallel or substantially parallel to the thrust space surfaces delimiting the annular combustion space.

It is favorable if the plurality of first propellant inlets define first propellant inlet longitudinal axes and if the first propellant inlet longitudinal axes point into the first portion in a direction parallel or substantially parallel to tangents to the inner thrust space surface and/or the outer thrust space surface. The first propellant component can thus be introduced into the annular combustion space and flow through the thrust space in the direction predetermined by the propellant inlet longitudinal axes.

The thrust chamber device preferably comprises a first injection unit for injecting the at least one first propellant component into the thrust space through the plurality of first propellant inlets. With the first injection unit, the at least one first propellant component can be introduced into the thrust space in a defined manner, in particular with a predefined volume flow.

It is favorable if the thrust chamber device comprises a first propellant store for a first propellant component and if the first injection unit comprises a first conveying unit for conveying the at least one first propellant component from the first propellant store through the plurality of first propellant inlets into the thrust space. The first propellant component can thus, for example, be injected directly through the first propellant inlets from the first propellant store into the thrust space or before being introduced into the thrust space can cool the inner and/or outer nozzle wall when the first propellant component is conducted, for example, through inner and/or outer coolant channels in the nozzle walls before being introduced into the thrust space. The first conveying unit may be configured, in particular, in the form of a pump unit, for example in the form of a turbo pump.

It is advantageous if the first conveying unit has a suction side and a pressure side, if the suction side is fluidically connected to the first propellant store, and if the pressure side is fluidically connected to the outer coolant channels and/or the inner coolant channels. This design makes it possible, in particular, to convey the first propellant component with the first conveying unit through the inner and/or outer coolant channels.

In accordance with a further preferred embodiment, provision may be made that the plurality of second propellant inlets define second propellant inlet longitudinal axes and that the second propellant inlet longitudinal axes point into the first portion in a direction parallel or substantially parallel to tangents to the inner thrust space surface and/or the outer thrust space surface. Thus, the at least one second propellant component can be injected into the thrust space with high efficiency and low friction losses. In particular, it is thus possible to introduce the first propellant component and the at least one second propellant component into the thrust space in parallel with one another, namely already with an optimized flow direction that is predetermined by the thrust space.

It is favorable if the thrust chamber device comprises a second injection unit for injecting the at least one second propellant component into the thrust space through the plurality of second propellant inlets. With the second injection unit, the at least one second propellant component can be introduced into the thrust space in a defined manner, for example with a predefined volume flow. In particular, the second injection unit and the first injection unit can be operated in coordination with one another in order to set an optimal propellant mixture, in particular a stoichiometric mixture, for the combustion in the thrust space at all times.

It is advantageous if the thrust chamber device comprises at least one second propellant store for at least one second propellant component and if the second injection unit comprises a second conveying unit for conveying the at least one second propellant component from the second propellant store through the plurality of second propellant inlets into the thrust space. In this way, the second propellant component can be introduced into the thrust space in a simple and defined manner, for example with a predefined volume flow. The second propellant component, in particular, may be a liquid oxidizer. The second conveying unit may be configured, in particular, in the form of a pump unit, for example in the form of a turbo pump.

The first propellant component favorably forms the coolant. The thrust chamber device can thus be cooled in a simple and defined manner. In particular, an elaborate construction of the nozzle walls can thus be avoided because, for example, only coolant channels have to be formed for one of the propellant components for operating the thrust chamber device. In particular, an undesired reaction of the propellant components with one another before entering the thrust space can thus be avoided in a simple and secure manner.

An optimal cooling of the nozzle walls can be achieved, in particular, if the first propellant component is a liquid fuel. In particular, it may be liquid hydrogen or liquid methane or liquefied natural gas. A pressure of the first propellant component increases when same absorbs heat upon flowing through the nozzle walls. By this increase in pressure, in particular, a drive unit for the conveying units can be driven, for example a turbine, which is coupled to the conveying units in a driving manner.

The second propellant component is favorably a liquid oxidizer. For example, this may be liquid oxygen. Large volumes of gas can, in particular, be stored in liquid form in a compact manner, for example in a pressure tank.

It is favorable if the thrust chamber device comprises a drive unit for driving the first conveying unit and/or the second conveying unit. In particular, two drive units may be provided, which are each associated with one of the two conveying units. In particular, a drive unit may be coupled to both drive units in a driving manner, for example by way of a common drive shaft. The described designs make it possible, in particular, to use one of the two propellant components not only for combustion and thus for generating thrust with the thrust chamber device, but also in order to convey the propellant components from the respective propellant store directly or indirectly, i.e. in particular via coolant channels, into the thrust chamber.

The drive unit can be configured in the form of a turbine in a simple manner. For example, it may be configured in the form of a gas turbine.

A simple and compact structure of the thrust chamber device can be achieved, in particular, by the drive unit comprising a fluid inlet and a fluid outlet and by the fluid outlet being fluidically connected to the first propellant inlets.

In accordance with a further preferred embodiment, provision may be made that the outer coolant channels comprise outer coolant channel inlets and outer coolant channel outlets and that the inner coolant channels comprise inner coolant channel inlets and inner coolant channel outlets. This design makes it possible, in particular, to equip nozzle walls with coolant channels in the desired manner. The respective coolant channel inlets and coolant channel outlets may selectively be arranged or formed either near an end of the first portion pointing away from the third portion or at a distance from this end. For example, coolant can thus be directed through outer coolant channels in a direction from the third portion toward the first portion, and from the end of the first portion pointing away from the third section through inner coolant channels up to the end of the first portion pointing in the direction toward the second portion. Alternatively a coolant flow in the reverse direction may also be predetermined.

It is advantageous if the pressure side of the first conveying unit is fluidically connected to the outer coolant channel inlets, if the outer coolant channel outlets are fluidically connected to the inner coolant channel inlets, and if the inner coolant channel outlets are fluidically connected to the fluid inlet of the drive unit. Such a design enables, in particular, a serial cooling of the outer nozzle wall and the inner nozzle wall. This means, in particular, that the coolant first flows through the outer nozzle wall, then the inner nozzle wall, and then is fed to the drive unit. Providing a coolant flow in this way has advantages, in particular, when starting the thrust chamber device, because the coolant can overall be heated better due to the longer flow path, and therefore can drive the drive unit with high efficiency.

Furthermore, it may be favorable if the pressure side of the first conveying unit is fluidically connected to the outer coolant channel inlets and the inner coolant channel inlets and if the outer coolant channel outlets and the inner coolant channel outlets are fluidically connected to the fluid inlet of the drive unit. A design of that kind enables, in particular, a kind of parallel coolant flow of the coolant through the outer coolant channels on the one hand and through the inner coolant channels on the other hand. The coolant thereby absorbs less heat than in the case of a serial cooling of the two nozzle walls as described above. However, in the case of a parallel cooling of the nozzle walls, friction is reduced due to a shorter flow path of the coolant through the respective nozzle wall. A parallel cooling of the nozzle walls is advantageous, in particular, after starting the thrust chamber device, i.e., in particular, in a normal or load operation of the thrust chamber device.

It may further be advantageous if the pressure side of the first conveying unit is fluidically connected to the inner coolant channel inlets, if the inner coolant channel outlets are fluidically connected to the outer coolant channel inlets, and if the outer coolant channel outlets are fluidically connected to the fluid inlet of the drive unit. In this way, in particular, a serial cooling of the nozzle walls can be achieved, namely in such a way that with the coolant from the first propellant store first the inner nozzle wall is cooled and then the thus preheated coolant is used for cooling the outer nozzle wall and is thereby heated further. A serial cooling of the nozzle walls can be achieved in this way.

It is advantageous if the thrust chamber device comprises a coolant flow switching unit for selectively switching a coolant flow through the inner coolant channels and the outer coolant channels in parallel or in series. Such a coolant flow switching unit makes it possible, in particular, to selectively cool the nozzle walls in parallel or in series, as was discussed in detail above. In particular, the coolant flow switching unit may be configured in such a way that it is also able to be predetermined whether the serial cooling is to be carried out first in the inner nozzle wall or first in the outer nozzle wall.

The coolant flow switching unit can be formed in a simple manner if it comprises a valve unit.

Further, the invention relates to an engine, in particular for a flying object or an aircraft, comprising a thrust chamber device, said thrust chamber device comprising a thrust chamber with a thrust space that has a first portion, a second portion adjoining the first portion, and a third portion adjoining the second portion, wherein the thrust space is delimited in all three portions by an outer nozzle wall with an outer thrust space surface, which outer thrust space surface tapers in the first and second portion toward the third portion and in the third portion expands away from the second portion, wherein a narrowest point is formed at the transition from the second portion to the third portion, wherein the first portion is delimited by an inner nozzle wall with an inner thrust space surface, which tapers toward the second portion, and wherein formed between the inner thrust space surface and the outer thrust space surface is an annular combustion space, which extends over the first portion, wherein the thrust chamber device comprises a regenerative cooling unit for cooling the inner nozzle wall and the outer nozzle wall with a coolant.

An engine further developed in that way has the advantages already described above in connection with preferred embodiments of thrust chamber devices.

Further, the invention relates to a flying object or aircraft, comprising a first propellant store for at least one first propellant component, a second propellant store for at least one second propellant component, and an engine, in particular for a flying object or an aircraft, comprising a thrust chamber device, said thrust chamber device comprising a thrust chamber with a thrust space that has a first portion, a second portion adjoining the first portion, and a third portion adjoining the second portion, wherein the thrust space is delimited in all three portions by an outer nozzle wall with an outer thrust space surface, which outer thrust space surface tapers in the first and second portion toward the third portion and in the third portion expands away from the second portion, wherein a narrowest point is formed at the transition from the second portion to the third portion, wherein the first portion is delimited by an inner nozzle wall with an inner thrust space surface, which tapers toward the second portion, and wherein formed between the inner thrust space surface and the outer thrust space surface is an annular combustion space, which extends over the first portion, wherein the thrust chamber device comprises a regenerative cooling unit for cooling the inner nozzle wall and the outer nozzle wall with a coolant.

Due to the improved cooling of the nozzle walls of the thrust chamber device in conjunction with the compact design of the thrust chamber device, shorter and thus significantly lighter engines can be formed having the same system performance. This makes it possible to move greater payloads with the same amount of propellant.

Further, the invention relates to a method for operating a thrust chamber device, said thrust chamber device comprising a thrust chamber with a thrust space that has a first portion, a second portion adjoining the first portion, and a third portion adjoining the second portion, wherein the thrust space is delimited in all three portions by an outer nozzle wall with an outer thrust space surface, which outer thrust space surface tapers in the first and second portion toward the third portion and in the third portion expands away from the second portion, wherein a narrowest point is formed at the transition from the second portion to the third portion, wherein the first portion is delimited by an inner nozzle wall with an inner thrust space surface, which tapers toward the second portion, and wherein formed between the inner thrust space surface and the outer thrust space surface is an annular combustion space, which extends over the first portion, wherein the thrust chamber device comprises a regenerative cooling unit for cooling the inner nozzle wall and the outer nozzle wall with a coolant, wherein the inner nozzle wall and the outer nozzle wall are regeneratively cooled with a coolant.

As already described above in detail, an optimal cooling of the thrust chamber device, without injecting the first propellant component in excess into the thrust space, can be achieved. Thus, mass flow losses of the first propellant component can be minimized and overall a thrust chamber device can be operated more efficiently.

The first propellant component is favorably used as coolant. It is thus not necessary to carry a coolant that serves exclusively cooling purposes. The first propellant component can then first cool the nozzle walls before a reaction with a further propellant component, thus performing a sort of dual function.

It is favorable if the coolant is conducted in parallel through the outer nozzle wall and the inner nozzle wall. In particular, this is advantageous when the thrust chamber device is in a stable operating mode, as described above. Conducting in parallel through the nozzle walls means, in particular, dividing a coolant flow so that a portion thereof is conducted through the outer nozzle wall and another portion thereof is conducted through the inner nozzle wall. This approach is advantageous, in particular, when the engine is in a stable operating mode, i.e., in particular, in a normal or load operation. Friction losses upon the coolant flowing through the nozzle walls can thus be minimized.

Alternatively, it may be advantageous if the coolant is conducted first through the inner nozzle wall and then through the outer nozzle wall or if the coolant is conducted first through the outer nozzle wall and then through the inner nozzle wall. A so-called serial regenerative cooling of the nozzle walls can be achieved in this way. In this approach, a coolant flow as a whole is conducted first through one of the two nozzle walls and then through the other nozzle wall. Such a cooling mode is advantageous, in particular, when starting the thrust chamber device, because the coolant can heat up to a greater extent due to a longer flow path through the nozzle walls. The energy absorbed in the coolant can then be used, in particular, to drive a drive unit for conveying units for the propellants. This described cooling mode is advantageous, in particular, when starting the thrust chamber device.

A cooling mode is preferably changed when changing an operating mode of the thrust chamber device. As already described, a serial cooling of the nozzle walls can thus take place, for example when starting the thrust chamber device. Upon reaching a load mode of the thrust chamber device, for example, as described, a parallel cooling of the nozzle walls can then be switched into.

It is advantageous if in a start mode of the thrust chamber device a serial cooling mode is carried out, and if in a load mode of the thrust chamber device a parallel cooling mode is carried out. Parallel and serial have already been described in detail above. They define the flow through the nozzle walls either one after the other, i.e. in series, or in parallel, i.e. partly through the inner nozzle wall and partly through the outer nozzle wall. This approach enables, in particular, an optimized operation of the thrust chamber device, because the cooling of the nozzle walls can be optimally adapted to the respective operating mode of the thrust chamber device.

It is favorable if the coolant flows through the drive unit before or after flowing through the inner nozzle wall and the outer nozzle wall. An enthalpy absorption of the coolant by heat absorption from the nozzle walls can then be used, in particular, to drive the drive unit, which is provided for driving one or more conveying units for the required propellant components.

The coolant is preferably injected through the first propellant inlets into the thrust chamber after flowing through the inner nozzle wall and/or the outer nozzle wall. The coolant, i.e., in particular, the first propellant component, can thus be used not only for cooling the thrust chamber device, but also for generating thrust with the thrust chamber device.

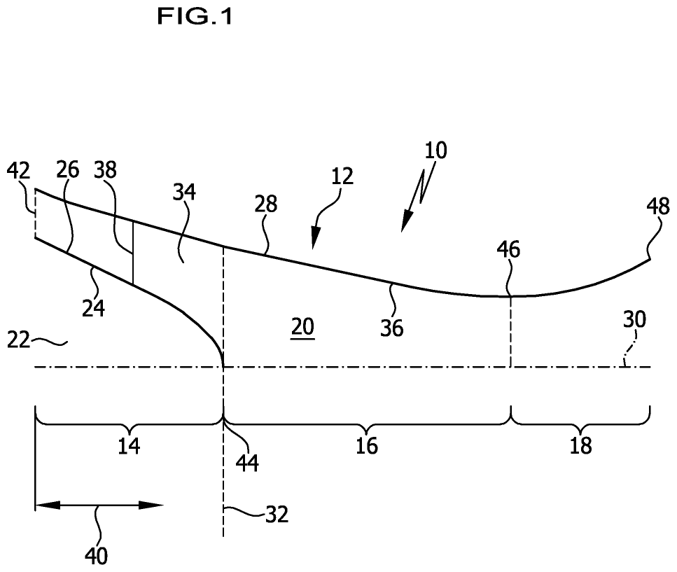

A first embodiment of a thrust chamber device 10 is schematically depicted in FIG. 1. The thrust chamber device 10 comprises a thrust chamber 12 with a first portion 14, a second portion 16, and a third portion 18, which divides a thrust space 20 of the thrust chamber 10 into corresponding portions 14, 16, and 18.

The first portion 14 is defined by an insertion body 22 inserted into the thrust space 20, which defines an inner nozzle wall 24 with an inner thrust space surface 26 of the thrust space 20.

The thrust space 20 is delimited on the outside by an outer nozzle wall 28, which is of rotationally symmetrical configuration relative to a longitudinal axis 30, namely in the form of a one-sheet hyperboloid of revolution.

The inner thrust space surface 26 has the form of a two-sheet hyperboloid of revolution. A tangent 32 in the transition between the first portion 14 and the second portion 16 to the insertion body 22 extends perpendicularly to the longitudinal axis 30.

The first portion 32 defines an annular combustion space 34 as part of the thrust space 20.

The outer nozzle wall 28 defines an outer thrust space surface 36 delimiting the thrust space 20.

In one embodiment, the thrust space surfaces 26 and 36 are selected such that a free cross-sectional area 38 is constant as a function of a distance 40 from a first end 42 of the first portion 14. The first end 42 delimits the first portion 14 pointing away from the second portion 16.

Commencing from the first end 42, an outer diameter of the annular surface defined by the annular combustion space 34 decreases in the direction toward the second portion 16, as well as a diameter of an inner delimitation of said annular surface by the inner thrust space surface 26. In the transition 54 between the first portion 14 and the second portion 16, the annular surface then transitions free of curvature into a circular surface, the cross section of which continues to taper toward the narrowest point 46 of the thrust space 20.

The narrowest point 46 is defined by a minimum diameter of the outer nozzle wall 28. Combustion gases are divergently accelerated through the narrowest point 46 toward a nozzle outlet 48. The third portion 18, which extends commencing from the narrowest point 46 toward the nozzle outlet 48, is also referred to as a supersonic region.

Due to the continuous curvature of the outer nozzle wall 28, disadvantages of a classic thrust chamber profile with a cylindrical combustion space and an adjoining Laval nozzle toward the nozzle outlet can be practically completely avoided. In the case of the classic profile, boundary layer turbulences typically arise in the region of the outer nozzle wall where the curvature direction thereof changes. By contrast, in the embodiment depicted in FIG. 1, the outer nozzle wall 28 is continuously curved, namely convexly curved pointing in the direction toward the longitudinal axis 30.

The inner nozzle wall 24 has a continuously convexly curved inner thrust space surface 26 pointing away from the insertion body 22.

Due to the constant cross section of the annular combustion chamber 34 as described in the case of the thrust chamber 12 depicted in FIG. 1, a quasi-cylindrical annular combustion space 34 is formed, but with the advantage that the outer thrust space surface 36 continuously tapers starting from the first end of 42, so that neither flow separation nor turbulence occurs in the region of the narrowest point 46.

By appropriately selecting a shape of the thrust space surfaces 26 and 36, the cross-sectional area 38 may be constant as described or alternatively increase or decrease in the direction toward the transition 44.

The second portion 16 extends from the transition 44 up to the narrowest point 46 and is delimited exclusively by the outer thrust space surface 36.

In the embodiment depicted in FIG. 1, the first portion 14 forms a quasi-cylindrical region. The second portion 16 forms a convergent region of the thrust space 20 and the third portion 18 forms the divergent supersonic region of the thrust chamber 12.

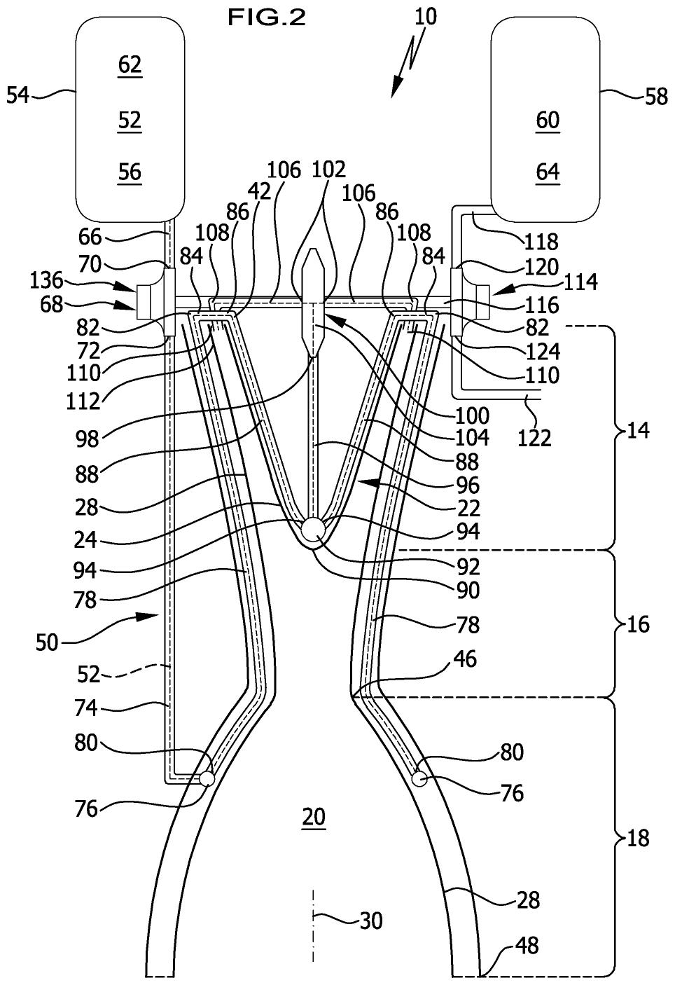

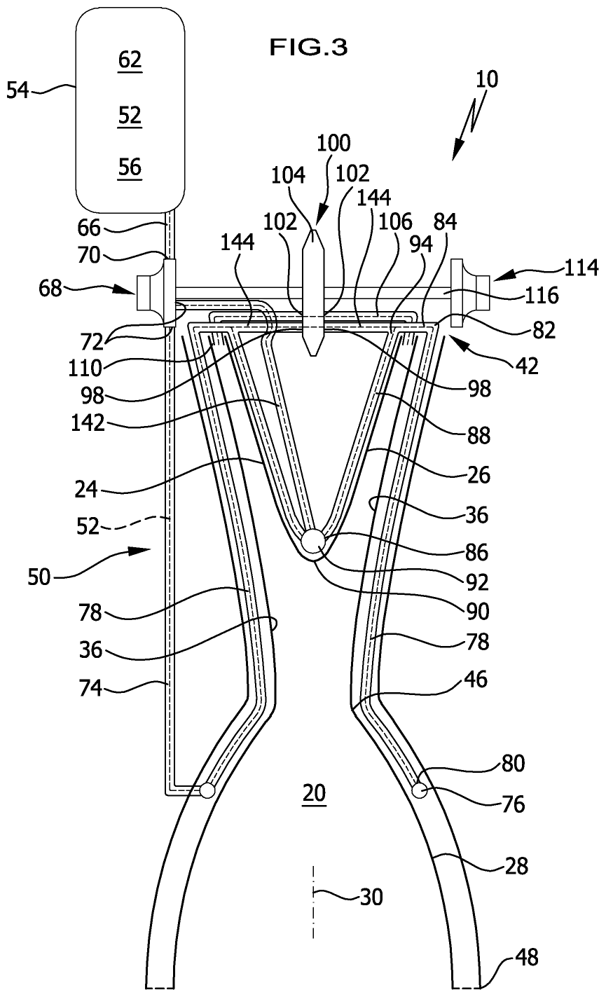

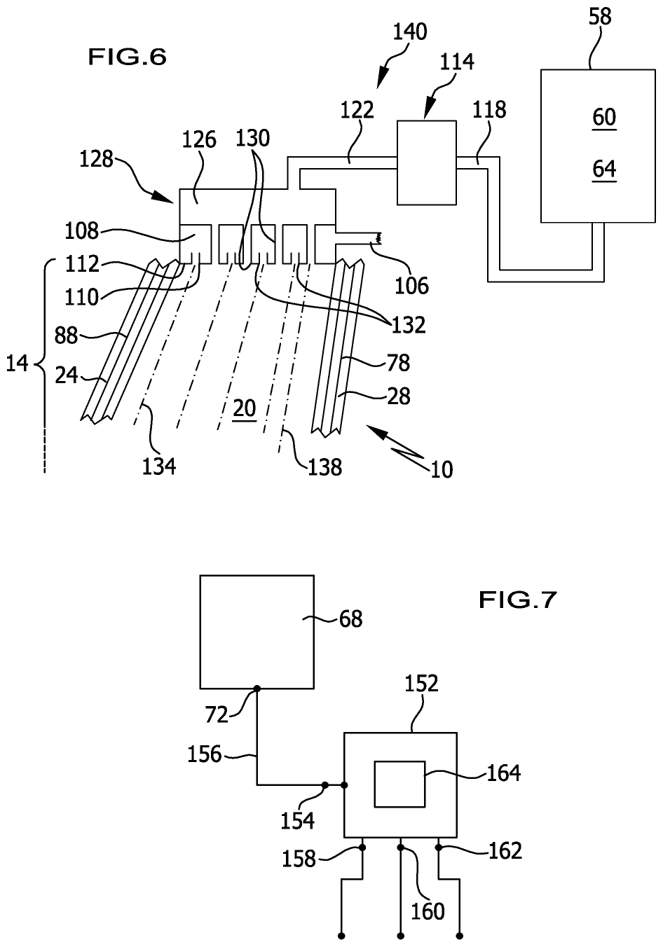

Depicted schematically in FIG. 2 is a further embodiment of a thrust chamber device, denoted as a whole with the reference numeral 10. For easier understanding, both in FIG. 2 and in the further FIGS. 3 to 9, the same reference numerals are used for identical or similar components of the thrust chamber device 10 that was described in connection with FIG. 1.

The thrust chamber device 10 comprises a regenerative cooling unit 50 for cooling the inner nozzle wall 24 and the outer nozzle wall 28 with a coolant 52.

The thrust chamber device 10 comprises a first propellant store 54 for a first propellant component 56 and a second propellant store 58 for a second propellant component 60.

In the described embodiment, a liquid fuel 62 is used as the first propellant component 56. An oxidizer 64 or oxidizing agent is used as the second propellant component 60. Both propellant components 56 and 60 are liquid and are cryogenically stored in the propellant stores 54 and 58, respectively.

In the embodiment of the thrust chamber device 10 depicted schematically in FIG. 2, the first propellant component 56 forms the coolant 52.

The first propellant store 54 is fluidically connected to a first conveying unit 68, namely with a suction side 70 thereof, by way of a connecting conduit 66. A pressure side 72 of the first conveying unit 68 is fluidically connected to an annular distributor 76 by way of a further connecting conduit 74, said annular distributor 76 annularly surrounding the outer nozzle wall 28 in the region of the third portion 18.

A plurality of outer coolant channels 78, which are fluidically connected to the annular distributor 76 with their outer coolant channel inlets 80, extend in the outer nozzle wall 28 from the annular distributor 76 up to the first end 42 of the thrust chamber device 10.

Outer coolant channel outlets 82 of the outer coolant channels 78 are fluidically connected to inner coolant channel inlets 86 of inner coolant channels 88 by way of connecting conduits 84.

The inner coolant channels 88, of which a plurality are provided, extend in the inner nozzle wall 24 up to the vicinity of a distal end 90 of the insertion body 22, and up to the vicinity of the second portion 16. Inner coolant channel outlets 94 of the inner coolant channels 88 are fluidically connected to one another by way of a collector 92.

The collector 92 is fluidically connected to a fluid inlet 98 of a drive unit 100 by way of a further connecting conduit 96.

A fluid outlet 102 of the drive unit 100, which is configured in the form of a turbine 104, is fluidically connected to a distribution space 108 by way of a connecting conduit 106. A plurality of first propellant inlets 110 extend from the distribution space 108 through an injection wall 112 into the first portion 114 of the thrust space 20.

In the described manner, the first propellant component 56 can be conveyed from the first propellant store 54 by means of the first conveying unit 68 through the coolant channels 78 and 80 to the drive unit 100. Upon flowing through the outer nozzle wall 28 and the inner nozzle wall 24, the first propellant component 56 is heated up, expands, and drives the turbine 104, which is connected to the first conveying unit 68 and a second conveying unit 114 in a driving manner. This is schematically depicted in FIG. 2 in the form of a drive shaft 116.

The first propellant component 56 thus serves not only as propellant, but also as coolant 52. In the described manner, a serial regenerative cooling of the nozzle walls 28 and 24 is achieved, namely first a cooling of the outer nozzle wall 28 and then a cooling of the inner nozzle wall 24 with the then already slightly heated coolant 52.

The serial cooling mode of the cooling unit 50 described above is advantageous, in particular, when starting the thrust chamber device 10. The coolant 52 is heated over a longer path and can thus absorb a greater amount of heat, which is advantageous for the operation of the drive unit 104.

The second propellant store 58 is fluidically connected to the second conveying unit 114, namely with the suction side 120 thereof, by way of a connecting conduit 118. A pressure side 124 of the second conveying unit 114 is fluidically connected to a distribution space 126 of an injection head 128 by way of a further connecting conduit 122. The distribution space 126 for the second propellant component 60 is fluidically connected to the first portion 14 of the thrust space 20 by way of a plurality of second propellant inlets 130 so that the second propellant component 60 can also be injected through the injection wall 112 into the annular combustion space 34.

The conveying units 68 and 114 are configured in the form of pump units, namely in the form of turbo pumps.

In one embodiment, the inner nozzle wall 24 and the outer nozzle wall 28 are made of a ceramic material.

In another embodiment of a thrust chamber device 10, the inner nozzle wall 24 and the outer nozzle wall 28 are made of a metallic material.

In a further embodiment of the thrust chamber device 10, the inner nozzle wall 24 and the outer nozzle wall 28 are made of a ceramic material and of a metallic material.

The inner nozzle wall 24 has the form of a hyperboloid of revolution both in the embodiment of the thrust chamber device 10 depicted in FIG. 2 and in the embodiment depicted in FIGS. 3 to 5. This also applies accordingly to the inner thrust space surface 26 and the outer thrust space surface 36.

In all embodiments of the thrust chamber device 10, the inner thrust space surface 26 is of convexly curved or substantially convexly curved configuration pointing toward the outer thrust space surface 36.

Furthermore, in all described embodiments of thrust chamber devices 10, the outer thrust space surface 36 is of convexly curved or substantially convexly curved configuration pointing in the direction toward the inner thrust space surface 26.

In addition, in all embodiments of thrust chamber devices 10, the thrust chambers 12 are of rotationally symmetrical configuration relative to their longitudinal axis 30. This also applies accordingly to the portions 14, 16, and 18.

Furthermore, in all embodiments of thrust chamber devices 10, the outer thrust space surface 36 and the inner thrust space surface 26 are of rotationally symmetrical configuration relative to the longitudinal axis 30.

The injection wall 112 delimits the thrust space 20 at the first end 42 of the first portion 14. The injection wall 112 connects the inner nozzle wall 24 and the outer nozzle wall 28 to one another. As already explained, the plurality of first propellant inlets 110 and the plurality of second propellant inlets 130 are arranged or formed in the injection wall 112 or pass therethrough.

The annular injection wall 112 closes the ring-shaped annular combustion space 34 at the first end 42.

The injection head 128 of the thrust chamber device 10 comprises the injection wall 112.

The plurality of first propellant inlets 110 and the plurality of second propellant inlets 130 are configured in the form of channels, which have channel openings 132 pointing into the annular combustion space 34.

The plurality of first propellant inlets 110 define first propellant inlet longitudinal axes 134, which point into the first portion 14 in a direction parallel or substantially parallel to tangents to the inner thrust space surface 26 or the outer thrust space surface 36.

Furthermore, the thrust chamber device 10 comprises a first injection unit 136 for injecting the first propellant component 56 into the thrust space 20 through the plurality of first propellant inlets 110. The first injection unit 136 comprises the first conveying unit 68.

The plurality of second propellant inlets 130 define second propellant inlet longitudinal axes 138, which point into the first portion 14 in a direction parallel or substantially parallel to tangents to the inner thrust space surface 26 or the outer thrust space surface 36.

The thrust chamber device 10 further comprises a second injection unit 140 for injecting the second propellant component 60 into the thrust space 20 through the plurality of second propellant inlets 130. Furthermore, the second injection unit 140 comprises the second conveying unit 114.

Schematically depicted in FIG. 3 is a further embodiment of a thrust chamber device, denoted as a whole with the reference numeral 10.

In this embodiment, a parallel regenerative cooling of the nozzle walls 24 and 28 is performable with their regenerative cooling unit 50.

As in the case of the embodiment of FIG. 2, the first conveying unit 68 is fluidically connected on the pressure side to the annular distributor 76 by way of the connecting conduit 74. Outer coolant channel inlets 80 of the outer coolant channels 78 are fluidically connected to the annular distributor 76 and extend through the outer nozzle wall 28 up to the first end 42.

The pressure side 72 is fluidically connected to the collector 92 by way of a connecting conduit 142. Inner coolant channel inlets 86 of the inner coolant channels 88 are fluidically connected to the collector 92. The inner coolant channels 88 extend in the inner nozzle wall 24 up to the first end 42 as well. Outer coolant channel outlets 82 are fluidically connected to inner coolant channel inlets 94 by way of the connecting conduit 84. The inner coolant channel outlets 94 are fluidically connected to the fluid inlet 98 of the drive unit 100 by way of connecting conduits 144. The connecting conduit 106 still fluidically connects the fluid outlet 102 to the distribution space 108.

The regenerative cooling unit 50 that is schematically depicted in FIG. 3 and is described above makes it possible to convey the coolant 52 with the first conveying unit 68 in parallel, i.e. partly through the outer coolant channels 78 and simultaneously partly through the inner coolant channels 88. Such a parallel cooling mode for operating the cooling unit 50 is advantageous, in particular, in a stationary mode or load mode of the thrust chamber device.

In the load mode of the thrust chamber device 10, the nozzle walls 24 and 28 are sufficiently heated, such that the coolant 52 is sufficiently heated already upon flowing through only the inner nozzle wall 24 or only the outer nozzle wall 28 in order to drive the drive unit 100 in the desired manner.

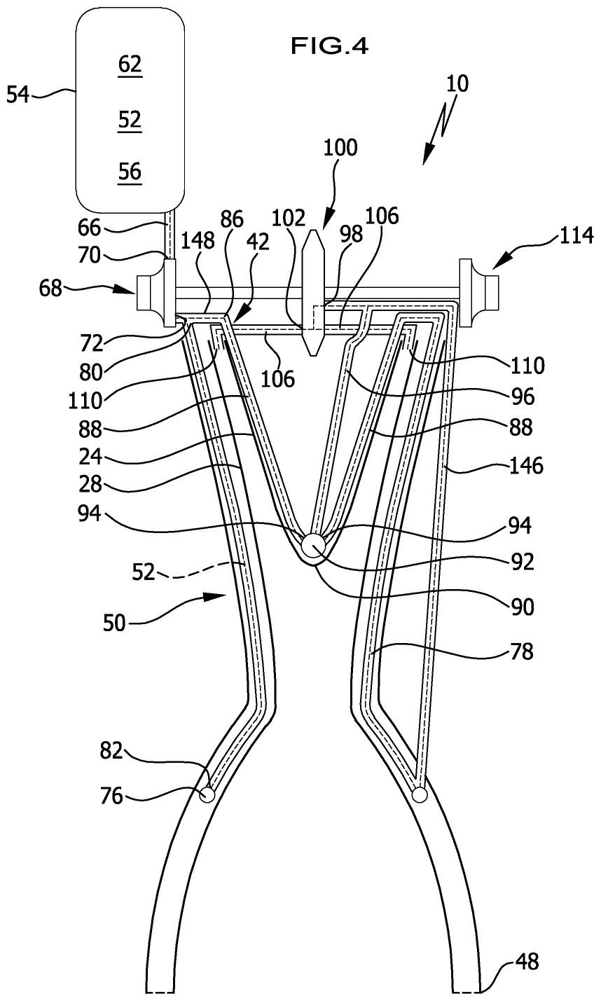

A further embodiment of a thrust chamber device 10 is schematically depicted in FIG. 4. It is similar in its functioning principle to the regenerative cooling unit 50 of the embodiment depicted in FIG. 3.

In the embodiment depicted in FIG. 4, outer coolant channel inlets 80 are fluidically connected to the pressure side 72 of the first conveying unit 68 and conduct the coolant 52 from the first end 42 to the annular distributor 76, which is fluidically connected to outer coolant channel outlets 82. The annular distributor 76, which in this embodiment has the function of a collector, is fluidically connected to the fluid inlet 98 of the drive unit 100 by way of a connecting conduit 146. Additionally, inner coolant channel inlets 86 are fluidically connected to the pressure side 72 by way of a connecting conduit 148.

Inner coolant channel outlets 94 are fluidically connected to the collector 92.

The collector 92 in turn is fluidically connected by way of the connecting conduit 96 either directly to the fluid inlet 98 or opens into the connecting conduit 146 before said fluid inlet 98.

The fluid outlet 102 of the drive unit 100 is connected to the distribution space 108 by way of connecting conduits 106.

In the embodiment of FIG. 4, a parallel cooling of the nozzle walls 24 and 28 is also possible. The coolant 52 is distributed from the conveying unit 68 to the inner and outer coolant channels 88 and 78, respectively, and thus flows either through the one or the other coolant channel 78 or 88. In contrast to the embodiment of FIG. 3, in the embodiment of FIG. 4 the cooling occurs starting from the first end 42 in the distal direction toward the third portion 18. In the embodiment of FIG. 3, the coolant 52 is conveyed in the direction toward the first end 42 through the nozzle walls 24 and 28 for cooling same.

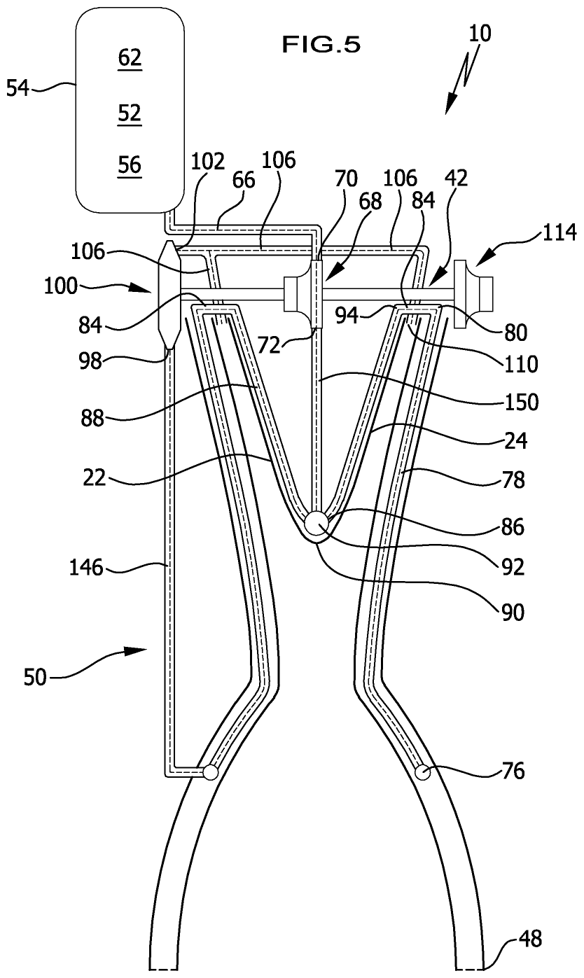

A further embodiment of a thrust chamber device 10 is schematically depicted in FIG. 5. It is similar in its functioning to the embodiment of FIG. 2 and enables a serial cooling mode of the regenerative cooling unit 50.

In this embodiment, the pressure side 72 is fluidically connected to the collector 92 in the region of the distal end 90 of the insertion body 22 by way of a connecting conduit 150. Inner coolant channel inlets 86 are directly fluidically connected to the collector 92 and in turn extend through the inner nozzle wall 24 in the direction toward the first end 42.

Connecting conduits 84 in the region of the first end 42 fluidically connect inner coolant channel outlets 94 to outer coolant channel inlets 80 in the region of the first end 42. The outer coolant channels 78 extend through the outer nozzle wall 28 up to the annular distributor 76, which in turn takes on the function of a collector in this embodiment.

The annular distributor 76 is fluidically connected to the fluid inlet 98 of the drive unit 100 by way of a connecting conduit 146. The fluid outlet 102 of the drive unit 100 in turn is fluidically connected to the distribution space 108 by way of connecting conduits 106.

A serial cooling of the nozzle walls 24 and 28 can be achieved with the embodiment of FIG. 5. Unlike in the embodiment of FIG. 2, where the coolant 52 first flows through the outer nozzle wall 28 and then the inner nozzle wall 24, in the embodiment of FIG. 5 the cooling takes places in precisely the reverse order. The coolant 52 is first conducted through the inner nozzle wall 24 and then through the outer nozzle wall 28.

Schematically depicted in FIG. 7 is a coolant flow switching unit 152. The embodiments of the thrust chamber devices 10 described above may optionally comprise such a coolant flow switching unit 152. If one is provided, an inlet 154 thereof is fluidically connected to the pressure side 72 of the first conveying unit 68 by way of a connecting conduit 156.

In the embodiment depicted in FIG. 7, the coolant flow switching unit 152 comprises three outlets 158, 160, and 162, which are connected to the inner and outer coolant channels 88 and 78 in such a way that the coolant flow switching unit 152 can be used to switch, for example, between a parallel cooling mode and a serial cooling mode. This makes it possible, in particular, with corresponding connection of the outlets 158, 160 and 162 with the coolant channels 78 and 88, to realize both the cooling modes described above in connection with the embodiments of FIGS. 2 and 3, i.e. on the one hand serial as in FIG. 2 or parallel as in FIG. 3. Alternatively, the embodiments of FIGS. 4 and 5 with the coolant flow switching unit 152 can be realized correspondingly on a single thrust chamber device 10, so that, for example, when starting the thrust chamber device 10, the regenerative cooling unit 50 is operated with a serial cooling mode, and during load operation or a stationary operation with a parallel cooling mode.

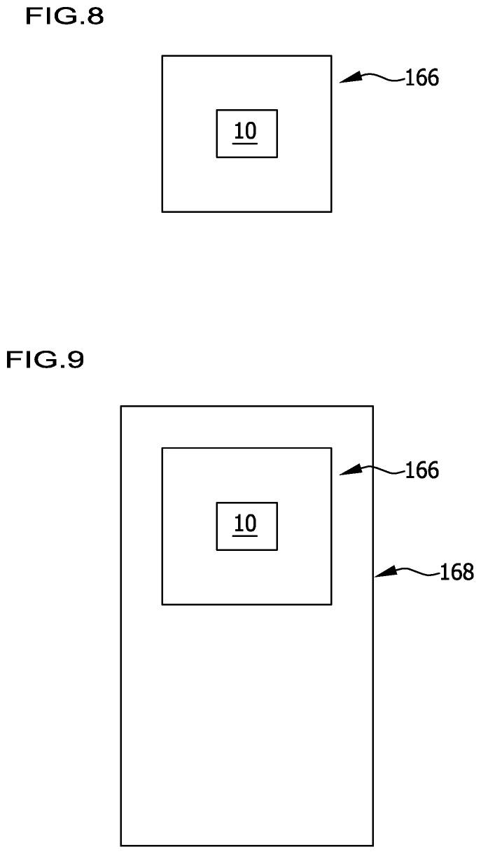

As schematically depicted in FIG. 8, an engine 166, for example for a flying object 168 or an aircraft, is equipped with a thrust chamber device 10. Here, the thrust chamber device 10 is configured in the form of a thrust chamber device 10 in accordance with one of the embodiments described above.

FIG. 9 shows schematically an embodiment of a flying object 168 or an aircraft, which comprises an engine 166 with a thrust chamber device 10. In one embodiment, the flying object 168 is configured in the form of a rocket.

The described embodiments of thrust chamber devices 10 enable an efficient cooling of the nozzle walls 24 and 28. In addition, due to the particular form of the inner and outer thrust space surfaces 26 and 36, an overall length of the respective thrust chamber 12 is significantly reduced compared to conventional thrust chamber devices with a cylindrical thrust space or a cylindrical combustion chamber that is followed by a Laval nozzle for forming the narrowest point. This makes it possible to form thrust chamber devices 10 with significantly reduced weight compared to known thrust chamber devices.

Thus, each of the thrust chamber devices 10 described above can transport a significantly higher payload, for example, into near-Earth space at the same power as a conventional thrust chamber device. Overall, a thrust chamber device 10 can thus be operated very efficiently.

### REFERENCE NUMERAL LIST

10 thrust chamber device
12 thrust chamber
14 first portion
16 second portion
18 third portion
20 thrust space
22 insertion body
24 inner nozzle wall
26 inner thrust space surface
28 outer nozzle wall
30 longitudinal axis
32 tangent
34 annular combustion space
36 outer thrust space surface
38 cross-sectional area
40 distance
42 first end
44 transition
46 narrowest point
48 nozzle outlet
50 cooling unit
52 coolant
54 first propellant store
56 first propellant component
58 second propellant store
60 second propellant component
62 fuel
64 oxidizer
66 connecting conduit
68 first conveying unit
70 suction side
72 pressure side
74 connecting conduit
76 annular distributor
78 outer coolant channel
80 outer coolant channel inlet
82 outer coolant channel outlet
84 connecting conduit
86 inner coolant channel inlet
88 inner coolant channel
90 distal end
92 collector
94 inner coolant channel outlet
96 connecting conduit
98 fluid inlet
100 drive unit
102 fluid outlet
104 turbine
106 connecting conduit
108 distribution space
110 first propellant inlet
112 injection wall
114 second conveying unit
116 drive shaft
118 connecting conduit
120 suction side
122 connecting conduit
124 pressure side
126 distribution space
128 injection head
130 second propellant inlets
132 channel opening
134 first propellant inlet longitudinal axis
136 first injection unit
138 second propellant inlet longitudinal axis
140 second injection unit
142 connecting conduit
144 connecting conduit
146 connecting conduit
148 connecting conduit
150 connecting conduit
152 coolant flow switching unit
154 inlet
156 connecting conduit
158 outlet
160 outlet
162 outlet
164 valve unit
166 engine
168 flying object

What is claimed is:

1. A thrust chamber device, comprising a thrust chamber with a thrust space that has a first portion, a second portion adjoining the first portion, and a third portion adjoining the second portion, wherein the thrust space is delimited in all three portions by an outer nozzle wall with an outer thrust space surface, which outer thrust space surface tapers in the first and second portion toward the third portion and in the third portion expands away from the second portion, wherein a narrowest point is formed at the transition from the second portion to the third portion, wherein the first portion is delimited by an inner nozzle wall with an inner thrust space surface, which tapers toward the second portion, and wherein formed between the inner thrust space surface and the outer thrust space surface is an annular combustion space, which extends over the first portion, wherein the thrust chamber device comprises a regenerative cooling unit for cooling the inner nozzle wall and the outer nozzle wall with a coolant.

2. The thrust chamber device in accordance with claim 1, wherein the regenerative cooling unit comprises a plurality of inner coolant channels in the inner nozzle wall and a plurality of outer coolant channels in the outer nozzle wall and wherein the plurality of inner coolant channels and the plurality of outer coolant channels are configured to be flowed through by the coolant.

3. The thrust chamber device in accordance with claim 1, wherein at least one of the inner nozzle wall and the outer nozzle wall are made at least one of a ceramic material and a metallic material.

4. The thrust chamber device in accordance with claim 1, wherein at least one of the inner thrust space surface and the outer thrust space surface at least partially have the form of a hyperboloid of revolution or have a continuously concave longitudinal sectional line.

5. The thrust chamber device in accordance with claim 1, wherein at least one of
a) the inner thrust space surface is of convexly curved or substantially convexly curved configuration pointing in the direction toward the outer thrust space surface
and
b) the outer thrust space surface is of convexly curved or substantially convexly curved configuration pointing in the direction toward the inner thrust space surface.

6. The thrust chamber device in accordance with claim 1, wherein at least one of
a) the thrust chamber defines a longitudinal axis and wherein the thrust chamber, in particular at least one of the first portion and the second portion and the third portion, are of rotationally symmetrical configuration relative to the longitudinal axis,
wherein, in particular, at least one of the outer thrust space surface and the inner thrust space surface are of rotationally symmetrical configuration relative to the longitudinal axis,
and
b) the annular combustion space has a constant or substantially constant cross sectional area.

7. The thrust chamber device in accordance with claim 1, wherein the thrust chamber device comprises a plurality of first propellant inlets for a first propellant component and a plurality of second propellant inlets for a second propellant component,
wherein, in particular, the first portion of the thrust space is delimited on an end pointing away from the second portion by an injection wall, which connects the inner nozzle wall and the outer nozzle wall to one another, and wherein the plurality of first propellant inlets and the plurality of second propellant inlets are arranged or formed in the injection wall,
wherein, further in particular, at least one of
a) the injection wall is of annular or rotationally symmetrical or hyperboloid-like configuration for closing the ring-shaped annular combustion space
and
b) the thrust chamber device comprises an injection head and wherein the injection head comprises the injection wall.

8. The thrust chamber device in accordance with claim 7, wherein at least one of
a) the plurality of first propellant inlets and the plurality of second propellant inlets are configured in the form of channels, which have channel openings pointing into the annular combustion space
and
b) the plurality of first propellant inlets define first propellant inlet longitudinal axes and wherein the first propellant inlet longitudinal axes point into the first portion in a direction parallel or substantially parallel to tangents to at least one of the inner thrust space surface and the outer thrust space surface.

9. The thrust chamber device in accordance with claim 7, further comprising a first injection unit for injecting the at least one first propellant component into the thrust space through the plurality of first propellant inlets,
wherein, in particular, the thrust chamber device comprises a first propellant store for a first propellant component and wherein the first injection unit comprises a first conveying unit for conveying the at least one first propellant component from the first propellant store through the plurality of first propellant inlets into the thrust space,
wherein, further in particular, the first conveying unit has a suction side and a pressure side, wherein the suction side is fluidically connected to the first propellant store, and wherein the pressure side is fluidically connected to at least one of the outer coolant channels and the inner coolant channels.

10. The thrust chamber device in accordance with claim 7, wherein at least one of
a) the plurality of second propellant inlets define second propellant inlet longitudinal axes and wherein the second propellant inlet longitudinal axes point into the first portion in a direction parallel or substantially parallel to tangents to at least one of the inner thrust space surface and the outer thrust space surface
and
b) the thrust chamber device further comprising a second injection unit for injecting the at least one second propellant component into the thrust space through the plurality of second propellant inlets, wherein, in particular, the thrust chamber device comprises at least one second propellant store for at least one second propellant component and wherein the second injection unit comprises a second conveying unit for conveying the at least one second propellant component from the second propellant store through the plurality of second propellant inlets into the thrust space.

11. The thrust chamber device in accordance with claim 7, wherein at least one of
a) the first propellant component forms the coolant
and
b) the first propellant component is a liquid fuel, in particular liquid hydrogen or liquid methane or liquefied natural gas,
and
c) the second propellant component is a liquid oxidizer, in particular liquid oxygen.

12. The thrust chamber device in accordance with claim 9, wherein the thrust chamber device comprises a drive unit for driving at least one of the first conveying unit and the second conveying unit,
wherein, in particular, the drive unit at least one of
a) is configured in the form of a turbine, in particular a gas turbine,
and
b) comprises a fluid inlet and a fluid outlet and wherein the fluid outlet is fluidically connected to the first propellant inlets.

13. The thrust chamber device in accordance with claim 2, wherein the outer coolant channels comprise outer coolant channel inlets and outer coolant channel outlets and wherein the inner coolant channels comprise inner coolant channel inlets and inner coolant channel outlets.

14. The thrust chamber device in accordance with claim 13, wherein at least one of
a) the pressure side of the first conveying unit is fluidically connected to the outer coolant channel inlets, wherein the outer coolant channel outlets are fluidically connected to the inner coolant channel inlets, and wherein the inner coolant channel outlets are fluidically connected to the fluid inlet of the drive unit
and
b) the pressure side of the first conveying unit is fluidically connected to the outer coolant channel inlets and the inner coolant channel inlets, and wherein the outer coolant channel outlets and the inner coolant channel outlets are fluidically connected to the fluid inlet of the drive unit
and
c) the pressure side of the first conveying unit is fluidically connected to the inner coolant channel inlets, wherein the inner coolant channel outlets are fluidically connected to the outer coolant channel inlets, and wherein the outer coolant channel outlets are fluidically connected to the fluid inlet of the drive unit
and
d) the thrust chamber device comprises a coolant flow switching unit for selectively switching a coolant flow in parallel or serially through the inner coolant channels and the outer coolant channels,
wherein, in particular, the coolant flow switching unit comprises a valve unit.

15. An engine, in particular for a flying object or an aircraft, comprising a thrust chamber device, said thrust chamber device comprising a thrust chamber with a thrust space that has a first portion, a second portion adjoining the first portion, and a third portion adjoining the second portion, wherein the thrust space is delimited in all three portions by an outer nozzle wall with an outer thrust space surface, which outer thrust space surface tapers in the first and second portion toward the third portion and in the third portion expands away from the second portion, wherein a narrowest point is formed at the transition from the second portion to the third portion, wherein the first portion is delimited by an inner nozzle wall with an inner thrust space surface, which tapers toward the second portion, and wherein formed between the inner thrust space surface and the outer thrust space surface is an annular combustion space, which extends over the first portion, wherein the thrust chamber device comprises a regenerative cooling unit for cooling the inner nozzle wall and the outer nozzle wall with a coolant.

16. A flying object or aircraft, comprising a first propellant store for at least one first propellant component, a second propellant store for at least one second propellant component, and an engine in accordance with claim 15.

17. A method for operating a thrust chamber device, said thrust chamber device comprising a thrust chamber with a thrust space that has a first portion, a second portion adjoining the first portion, and a third portion adjoining the second portion, wherein the thrust space is delimited in all three portions by an outer nozzle wall with an outer thrust space surface, which outer thrust space surface tapers in the first and second portion toward the third portion and in the third portion expands away from the second portion, wherein a narrowest point is formed at the transition from the second portion to the third portion, wherein the first portion is delimited by an inner nozzle wall with an inner thrust space surface, which tapers toward the second portion, and wherein formed between the inner thrust space surface and the outer thrust space surface is an annular combustion space, which extends over the first portion, wherein the thrust chamber device comprises a regenerative cooling unit for cooling the inner nozzle wall and the outer nozzle wall with a coolant, wherein the inner nozzle wall and the outer nozzle wall are regeneratively cooled with a coolant.

18. The method in accordance with claim 17, wherein at least one of
a) the first propellant component is used as coolant
and
b) the coolant is conducted in parallel through the outer nozzle wall and the inner nozzle wall, in particular when the thrust chamber device is in a stable operating mode.

19. The method in accordance with claim 17, wherein the coolant is conducted
a) first through the inner nozzle wall and then through the outer nozzle wall
or
b) first through the outer nozzle wall and then through the inner nozzle wall.

20. The method in accordance with claim 17, wherein at least one of
a) a cooling mode is changed when changing an operating mode of the thrust chamber device,
wherein, in particular, in a start mode of the thrust chamber device a serial cooling mode is performed in accordance with claim 19 and wherein in a load mode of the thrust chamber device a parallel cooling mode is performed in accordance with claim 18,
and
b) the coolant flows through the drive unit before or after flowing through the inner nozzle wall and the outer nozzle wall
and
c) the coolant is injected through the first propellant inlets into the thrust chamber after flowing through at least one of the inner nozzle wall and the outer nozzle wall.
